(19) United States
(12) Patent Application Publication
(10) Pub. No.: US 2011/0234306 A1
(43) Pub. Date: Sep. 29, 2011

(54) BOOSTER CIRCUIT

(75) Inventors: Takeshi HIOKA, Yokohama-Shi (JP); Daisaburo Takashima, Yokohama-Shi (JP)

(73) Assignee: KABUSHIKI KAISHA TOSHIBA, Tokyo (JP)

(21) Appl. No.: 13/047,088

(22) Filed: Mar. 14, 2011

(30) Foreign Application Priority Data
Mar. 25, 2010 (JP) 2010-070788

(51) Int. Cl. G05F 1/10

(52) U.S. Cl. 327/537

(57) ABSTRACT

In a booster, a first transistor of a second conduction-type is formed on a first conduction-type substrate and connected to between a voltage-source and an output so that the first transistor functions as a diode. A first capacitor is connected to a first node of the first transistor on a voltage-source side, and transmits a first clock to the first node. A second transistor of the first conduction-type is connected to a second node of the first transistor on an output side to receive the first clock. A second capacitor is connected to the second node and transmits a second clock having an opposite phase of the first clock to the second node. The first transistor transfers the first node's voltage stepped up by the first clock to the second node. The second transistor transfers the second node's voltage stepped up by the second clock to an output side.

### CROSS REFERENCE TO RELATED APPLICATIONS

This application is based upon and claims the benefit of priority from the prior Japanese Patent Application No. 2010-70788, filed on Mar. 25, 2010, the entire contents of which are incorporated herein by reference.

### FIELD

The embodiments of the present invention relate to a booster circuit.

### BACKGROUND

A Dickson charge pump circuit is frequently used for a power supply or the like of a semiconductor device. Types of the Dickson charge pump circuit include an NMOS (N-type Metal-Oxide Semiconductor) booster circuit and a PMOS booster circuit. For example, the NMOS booster circuit includes a plurality of diode-connected NMOSs and a plurality of capacitors connected to drains of the NMOS, respectively. One NMOS and one capacitor are paired to constitute a booster step. A plurality of booster steps performs a boosting operation by receiving clock signals via the corresponding capacitors, respectively. At this time of the operation, a voltage of each booster step is stepped up by as much as a voltage obtained by subtracting a threshold voltage of the NMOS from an amplitude (a voltage) of the clock signal. The booster step transfers the step-up voltage to the next booster step. A fall (a loss) in the step-up voltage in each booster step causes deterioration in the boosting efficiency and a reduction in boosting speed. To deal with problems like these, there is proposed extending an area of each capacitor. However, if the area is extended, then a chip area of the semiconductor device and current consumption for charging the capacitors disadvantageously increase.

On the other hand, the PMOS booster circuit uses a plurality of PMOSs in place of NMOSs. The PMOMSs are normally formed on a surface of an N-well formed in a P-substrate. In this case, there is a probability that the PMOS malfunctions due to a step-up high voltage and electric charges (hereinafter, “charges”) reversely flow in each booster step. It is, therefore, necessary to control each PMOS to be turned on or off using a gate voltage and to use a gate voltage control circuit to prevent reverse flow of charges. Furthermore, it is necessary to use a well voltage control circuit controlling a well voltage so as not to apply a forward bias to a junction between the well and a source or drain diffusion layer. As a result, similarly to the NMOS booster circuit, the PMOS booster circuit has problems of an increase in a chip area of the semiconductor device and an increase in current consumption.

Note that these problems remain unsolved even if an N-substrate is used in place of the P-substrate because situations of the PMOS booster circuit are simply replaced by those of the NMOS booster circuit.

### BRIEF DESCRIPTION OF THE DRAWINGS

FIG. 1 is a circuit diagram showing a configuration of a booster circuit according to a first embodiment;

FIGS. 2A and 2B are cross-sectional views of an NMIS transistor Tni and a PMIS transistor Tpi;

FIG. 3 is a graph showing an operation performed by the last booster step BST2 in the booster circuit according to the first embodiment;

FIG. 4 is a graph showing a simulation result of a booster circuit according to a comparison and the booster circuit according to the first embodiment;

FIG. 5 is a graph showing the operation performed by the booster circuit in which the PMIS transistor is provided in the booster step in front of the last booster step;

FIGS. 6A and 6B are circuit diagrams showing a configuration of the booster circuit according to the second embodiment;

FIGS. 7A and 7B are circuit diagrams showing a configuration of a booster circuit according to a third embodiment;

FIGS. 8A to 8C are circuit diagrams showing a configuration of a booster circuit according to a fourth embodiment; and

FIGS. 9A and 9B are circuit diagrams showing a configuration of a booster circuit according to a fifth embodiment.

### DETAILED DESCRIPTION

In a booster circuit according to the present invention, a first MIS transistor of a second conduction type is formed on a substrate of a first conduction type and connected to between a voltage source and an output in such a manner that the first MIS transistor functions as a diode. A first capacitor is connected to a first node of the first MIS transistor on a voltage source side, and transmits a first clock to the first node. A second MIS transistor of the first conduction type is connected to a second node of the first MIS transistor on an output side, and a gate of the second MIS transistor receives the first clock. A second capacitor is connected to the second node and transmits a second clock opposite in a phase to the first clock to the second node. The first MIS transistor transfers a voltage of the first node stepped up by the first clock to the second node. The second MIS transistor transfers a voltage of the second node stepped up by the second clock to an output side.

Embodiments will now be explained with reference to the accompanying drawings. Note that the present invention is not limited thereto.

A booster circuit according to each of the following embodiments is applied to a so-called Dickson charge pump circuit and can be used to step up a supply voltage Vsup and to output the stepped-up supply voltage in and from a power supply or the like of each of semiconductor devices of various types.

### First Embodiment

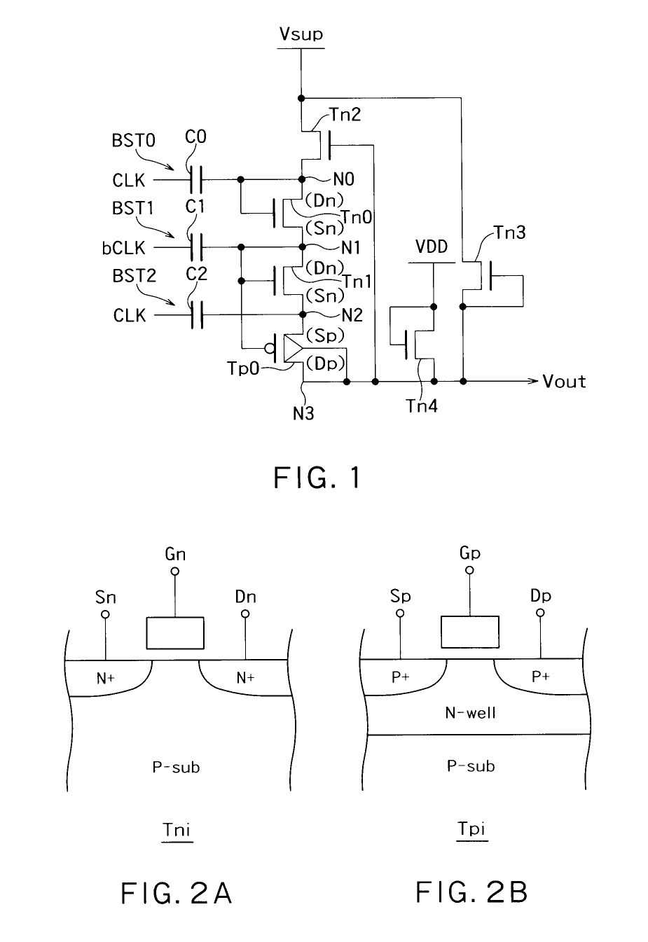

FIG. 1 is a circuit diagram showing a configuration of a booster circuit according to a first embodiment. This booster circuit can be used, for example, in a power supply of a NAND flash memory.

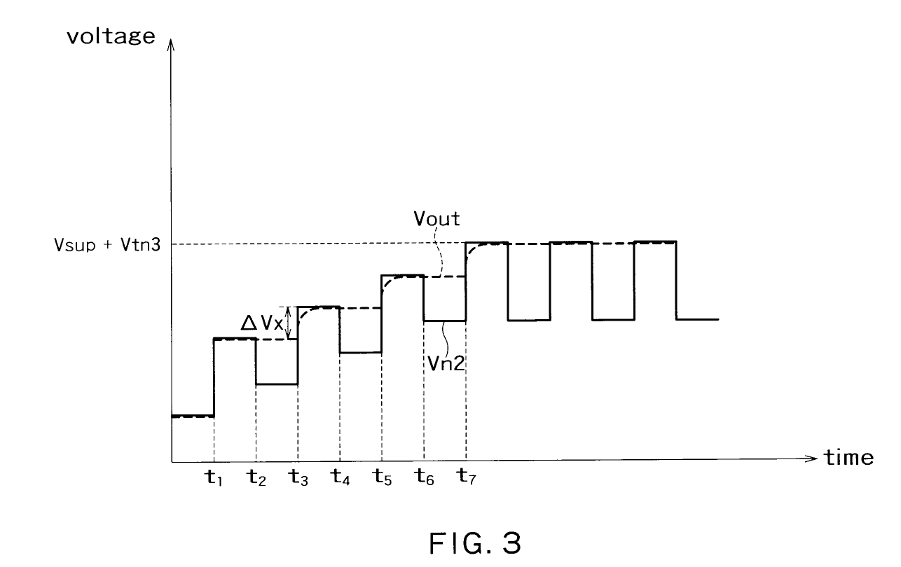

The booster circuit according to the first embodiment includes NMIS (Metal-Insulator Semiconductor) transistors Tn0 to Tn4, a PMIS transistor Tp0, and capacitors C0 to C2. FIGS. 2A and 2B are cross-sectional views of an NMIS transistor Tni and a PMIS transistor Tpi (where i is an integer), respectively.

The NMIS transistor Tn0 (hereinafter, also “transistor Tn0”) is connected to between nodes N0 and N1, and a gate Gn of the NMIS transistor Tn0 is connected to the node N0 in common with a drain Dn thereof. That is, the transistor Tn0 is connected to between the nodes N0 and N1 so as to function as a diode. Connection of this type is also referred to as “diode connection” hereinafter. An anode-side diffusion layer (drain Dn) of the transistor Tn0 is connected to the node N0, and a cathode-side diffusion layer Sn thereof is connected to the node N1.

One end of the capacitor C0 receives a clock signal CLK and the other end of the capacitor C0 is connected to the node N0. That is, the capacitor C0 is configured to be connected to the node N0 on an anode side of the transistor Tn0 and to transmit the clock signal CLK to the node N0. The node N0 receives the clock signal CLK via the capacitor C0.

The transistor Tn0 and the capacitor C0 are paired to constitute a booster step BST0 initially stepping up a supply voltage Vsup.

The NMIS transistor Tn1 (hereinafter, also “transistor Tn1”) serving as a first MIS transistor is connected to between nodes N1 and N2, and a gate Gn of the NMIS transistor Tn1 is connected to the node N1 in common with a drain Dn thereof. That is, the transistor Tn1 is connected to between the nodes N1 and N2 so as to function as a diode. An anode-side diffusion layer (drain Dn) of the transistor Tn1 is connected to the node N1, and a cathode-side diffusion layer Sn thereof is connected to the node N2.

One end of the capacitor C1 serving as a first capacitor receives a clock signal bCLK opposite in a phase to the clock signal CLK and the other end of the capacitor C1 is connected to the node N1. That is, the capacitor C1 is configured to be connected to the node N1 on the anode side of the transistor Tn1 and to transmit the clock signal bCLK to the node N1. The node N1 receives the clock signal bCLK via the capacitor C1. In the first embodiment, the clock signal bCLK is a signal opposite in a phase to the clock signal CLK. The clock signal CLK is expressed to indicate a second clock and the clock signal bCLK is expressed to indicate a first clock.

The transistor Tn1 and the capacitor C1 are paired to constitute a second booster step BST1.

The PMIS transistor Tp0 (hereinafter, also “transistor Tp0”) serving as a second MIS transistor is connected to between nodes N2 and N3. A gate Gp of the transistor Tp0 receives the clock signal bCLK in common with the gate of the transistor Tn1. That is, the transistor Tp0 is connected to the node N2 on a cathode side of the transistor Tn1 and the gate Gp thereof receives the clock signal bCLK serving as the first clock.

One end of the capacitor C2 serving as a second capacitor receives the clock signal CLK and the other end of the capacitor C2 is connected to the node N2. That is, the capacitor C2 is configured to transmit the clock signal CLK to the node N2.

The transistor Tp0 and the capacitor C2 are paired to constitute a last booster step BST2.

The three booster steps BST0 to BST2 described above are connected in series between the node N0 on a supply voltage (Vsup)-side and the node N3 on an output (Vout)-side. The booster steps BST0 to BST2 receive the clock CLK or bCLK and step up voltages of the nodes N0 to N2, respectively. More specifically, the booster step BST0 steps up a voltage Vn0 of the node N0 by the clock signal CLK and the transistor Tn0 transfers the step-up voltage Vn0 to the node N1. The booster step BST1 steps up a voltage Vn1 of the node N1 by the clock signal bCLK and the transistor Tn1 transfers the step-up voltage Vn1 to the node N2. The booster step BST2 steps up a voltage Vn2 of the node N2 by the clock signal CLK and the transistor Tp0 transfers the step-up voltage Vn2 to the output side.

Since the clock signals CLK and bCLK are opposite in phase, the transistor Tp0 is turned on by the clock signal bCLK when the voltage Vn2 of the node N2 of the last booster step BST2 is stepped up by the clock signal CLK. As a result, the step-up voltage Vn2 of the node N2 is transferred to the node N3.

In case of each of the diode-connected transistors Tn0 and Tn1, the step-up voltage is stepped down by as much as a threshold voltage of the transistor Tn0 or Tn1 and the stepped-down voltage is transferred to the next booster step. For example, it is assumed that threshold voltages of the transistors Tn0 and Tn1 are Vtn0 and Vtn1, respectively, and that the voltages of the nodes N0 to N2 are Vn0 to Vn2, respectively. In this case, the booster step BST0 transfers a voltage (Vn0−Vtn0) obtained by subtracting the threshold voltage Vtn0 from the voltage Vn0 of the node N0 stepped up by the clock signal CLK to the node N1. Next, the booster step BST1 transfers a voltage (Vn1−Vtn1) obtained by subtracting the threshold voltage Vtn1 from the voltage Vn1 of the node N1 stepped up by the clock signal bCLK to the node N2.

In the last booster step BST2, the voltage Vn2 of the node N2 is equal to a voltage obtained by stepping up the voltage (Vn1−Vtn1) when the clock signal CLK rises to a high level. At this moment, the clock signal bCLK falls to a low level. Due to this, a gate voltage of the transistor Tp0 is sufficiently lower than a voltage of the source Sp (source voltage), and the transistor Tp0 transfers the step-up voltage Vn2 to the node N3 without stepping down the step-up voltage Vn2. At this moment, the gate voltage of the transistor Tp0 is lower than the source voltage by as much as the threshold voltage of the transistor Tp0 or higher. In the first embodiment, therefore, the transistor Tp0 of the last booster step BST2 can prevent the voltage Vn2 of the node N2 from being stepped down, that is, the step-up voltage V2 from being stepped down by as much as the threshold voltage.

The NMIS transistor Tn2 (hereinafter, also “transistor Tn2”) is connected to between the node N0 and the supply voltage source (Vsup), and a gate Gn of the NMIS transistor Tn2 is connected to the output (Vout). The output voltage Vout is fed back to the transistor Tn2, and the transistor Tn2 connects or disconnects the supply voltage source (Vsup) to or from the node N0 based on a voltage level of the output voltage Vout.

The NMIS transistor Tn3 (hereinafter, also “transistor Tn3”) is connected to between the output (Vout) and the supply voltage source (Vsup) to function as a diode. A drain of the transistor Tn3 (on an anode side thereof) is connected to the output (Vout), and a source of the transistor Tn3 (on a cathode side thereof) is connected to the supply voltage source (Vsup). The transistor Tn3 functions as a limiter that limits a maximum value of the output voltage Vout to (Vsup+Vtn3). Note that Vtn3 is a threshold voltage of the transistor Tn3.

The NMIS transistor Tn4 (hereinafter, also “transistor Tn4”) is diode-connected to between a power supply VDD and the output (Vout). The transistor Tn4 charges a drain voltage of the transistor Tp0 of the last booster step BST3 (voltage of the node N3) up to VDD. At the start of a boosting operation, the drain voltage of the transistor Tp0 is stepped up to some extent in advance. This can prevent a forward bias from being applied to a junction between a P⁺ drain and an N-well of the transistor Tp0 even if the source voltage and a well voltage of the transistor Tp0 are stepped up by the boosting operation. The power supply voltage VDD can be set arbitrarily to be equal to or higher than 0 and equal to or lower than Vsup.

FIG. 3 is a graph showing an operation performed by the last booster step BST2 in the booster circuit according to the first embodiment. In the graph, a solid line indicates the voltage of the node N2 and a broken line indicates that of the node N3. Note that the voltage of the node N2 is shown as an ideal rectangular wave for convenience's sake.

At a time t1, the clock signal CLK rises, thereby stepping up the voltage Vn2 of the node N2. At the same time, the clock signal bCLK falls to the low level. Due to this, the transistor Tp0 transfers the step-up voltage Vn2 of the node N2 to the node N3 without stepping down the step-up voltage Vn2.

At a time t2, the clock signal CLK falls and the clock signal bCLK rises. At this time, the voltage Vn2 of the node N2 falls according to falling of the clock signal CLK. Further, the transistor Tp0 is turned off according to rising of the clock signal bCLK. In addition, the node N3 does not receive any clock signal, so that the voltage (Vout) of the node N3 is kept equal to the voltage Vn2. As a result, the source voltage (Vn2) of the transistor Tp0 is set lower than the drain voltage (Vout). However, no forward bias is applied to the junction between the P⁺ source Sp and the N-well of the transistor Tp0 since a voltage of a body (an N-well) of the transistor Tp0 is kept equal to the output voltage Vout higher than Vn2. Accordingly, a PNP bipolar transistor constituted by the P⁺ source and the N-well of the transistor Tp0 and a P-substrate is not turned on, and no current flows from the source to the P-substrate. Since a voltage of a drain Dp of the transistor Tp0 is kept equal to the voltage Vout similarly to the N-well, no current flows from the drain Dp of the transistor Tp0 to the P-substrate, either. This means that the transistor Tp0 hardly has a voltage drop (a loss) from the time t2 to a time t3.

Next, at the time t3, the clock signal CLK rises to the high level again. At this time, similarly to t1, the transistor Tp0 is turned on and transfers the step-up voltage V2 of the node N2 to the node N3. The voltage Vout of the node N3 rises according to the voltage Vn2. After a time t4, the booster circuit repeatedly performs the boosting operation from the times t2 to t4, thereby stepping up the output voltage Vout to (Vsup+Vtn3).

According to the first embodiment, the PMIS transistor is used in one of a plurality of booster steps of the booster circuit and the NMIS transistors are used in the other booster steps. That is, the booster circuit according to the first embodiment is a mixture of the booster step using the PMIS transistor and the booster steps using the NMIS transistors, respectively. In the booster steps each using the NMIS transistor, the NMIS transistors are diode-connected. Due to this, each booster step using the NMIS transistor has a loss in the step-up voltage by as much as the threshold voltage of the NMIS transistor. However, the last booster step using the PMIS transistor has no loss in the step-up voltage by as much as the threshold voltage and can transfer the step-up voltage to the output side without stepping down the step-up voltage. Elimination of the voltage loss in the last booster step can improve the boosting efficiency of the booster circuit.

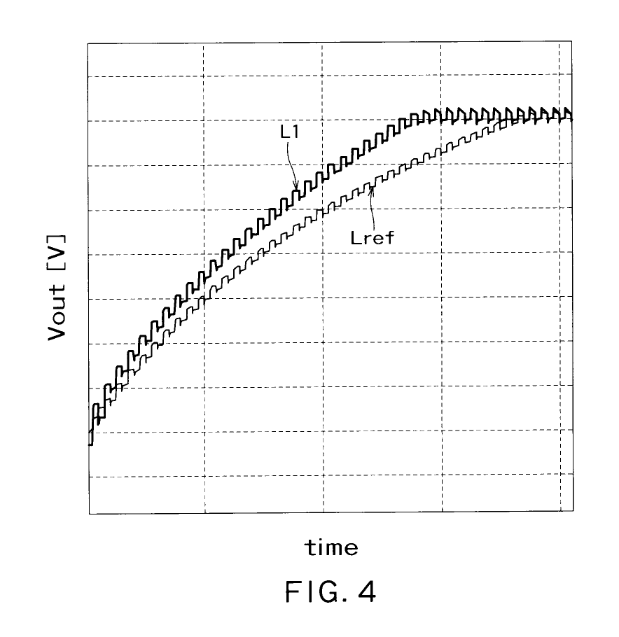

FIG. 4 is a graph showing a simulation result of a booster circuit constituted by booster steps each of which uses an NMIS transistor according to a comparison and the booster circuit that is the mixture of the booster steps using the PMIS transistor and the booster steps each using the NMIS transistor according to the first embodiment. The graph of FIG. 4 shows a state where the output voltage Vout gradually rises according to the clock signal.

According to the comparison (Lref), each of all the booster steps has a voltage loss corresponding to a threshold voltage. Due to this, the booster circuit is relatively low in the boosting efficiency and boosting speed. According to the first embodiment (L1), by contrast, the booster circuit is higher than that according to the comparison in the boosting efficiency and boosting speed because of lack of the voltage loss corresponding to the threshold voltage in the last booster step.

If only one booster step uses the PMIS transistor as shown in the first embodiment, the effects of this embodiment are greater as the total number of booster steps in the booster circuit is smaller. For example, a booster circuit used in a NAND flash memory uses three to five booster steps. In this way, if the number of booster steps is small, it is possible to greatly improve the boosting efficiency and the boosting speed by preventing the voltage loss in one booster step. Specifically, as shown in FIG. 1, if the number of booster steps is three and the last booster step uses the PMIS transistor, the booster circuit according to the first embodiment can reduce the voltage loss to one-third of that of a booster circuit in which each of three booster steps uses an NMIS transistor.

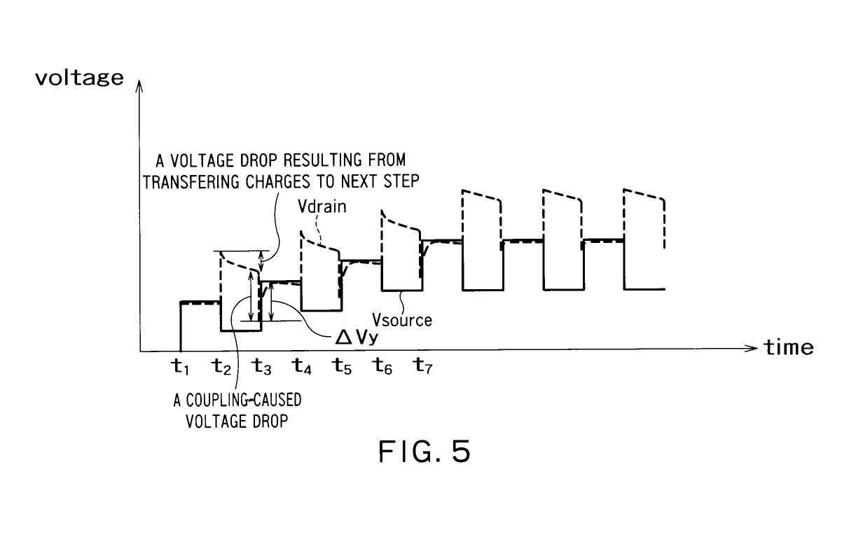

Furthermore, the booster circuit performs no boosting operation in the drain Dp of the transistor Tp0 (node N3) by using the PMIS transistor Tp0 in the last booster step BST2. If the PMIS transistor Tp0 is provided in the booster step in front of the last booster step BST2, a booster circuit performs the boosting operation alternately in not only the source Sp but also the drain Dp in response to the clock signal. FIG. 5 is a graph showing the operation performed by the booster circuit in which the PMIS transistor is provided in the booster step in front of the last booster step. If the PMIS transistor is provided in the booster step in front of the last booster step, a source voltage Vsource falls according to falling of a clock signal and a drain voltage Vdrain conversely rises according to rising of the clock signal at t2 as shown in FIG. 5. This makes a potential difference Vds between the source and drain of the transistor Tp0 quite large. An instantaneous rise of the drain voltage possibly causes application of a forward bias to the junction between the P⁺ drain Dp and the N-well even if the N-well is connected to the drain Dp. If the forward bias is applied to the junction between the junction between the P⁺ drain Dp and the N-well, current possibly flows from the drain Dp to the P-substrate P-sub.

According to the first embodiment, by contrast, the booster step using the PMIS transistor Tp0 is provided as the last booster step. This can dispense with the boosting operation in the drain Dp of the transistor Tp0 (node N3) as shown in t2 of FIG. 3. Without the boosting operation in the drain Dp of the transistor Tp0, the drain voltage and well voltage are kept equal to each other from t1 to t3. Due to this, no forward bias is applied to the junction between the P⁺ drain Dp and the N-well.

Moreover, a back bias is applied to the junction between the P⁺ drain Dp and the N-well since the source voltage of the transistor Tp0 falls at t2. Due to this, at t2, no current flows from the source Sp or drain Dp of the transistor Tp0 to the substrate P-sub.

Further, if the PMIS transistor Tp0 is provided in the booster step in front of the last booster step BST2, the drain voltage of the transistor Tp0 instantaneously falls to a lower voltage due to a voltage drop resulting from transfer of charges to the next booster step and a voltage drop (a coupling-caused voltage drop) resulting from falling of the clock signal. At this time, the source voltage of the transistor Tp0 rises according to rising of the clock signal. Therefore, at t3 similarly to t2, the potential difference Vds between the source Sp and drain Dp of the transistor Tp0 is quite large. However, the potential difference Vdst at t3 is opposite in polarity to that between the source Sp and drain Dp of the transistor Tp0 at t2. In this case, the forward bias is possibly applied to the junction between the P⁺ source Sp and the N-well.

On the other hand, according to the first embodiment, as shown in t3 of FIG. 3, no voltage drop resulting from the clock signal occurs to the drain Dp of the transistor Tp0 (node N3). Further, according to the first embodiment, no charges are supplied to the next step since the transistor Tp0 is provided in the last booster step BST2. Accordingly, the drain voltage and well voltage of the transistor Tp0 do not fall at t3. On the other hand, the source voltage (Vn2) of the transistor Tp0 rises according to rising of the clock signal. At this time, the potential difference Vds applied to the junction between the source Sp and drain Dp of the transistor Tp0 is ΔVx shown in FIG. 3. The potential difference ΔVx is smaller than a potential difference ΔVy shown in FIG. 5. Accordingly, a probability that current flows from the source Sp to the substrate P-sub is low as compared with the instance shown in FIG. 5. Moreover, it is possible to reduce the forward bias applied to the junction between the P⁺ source Sp and the N-well and prevent flow of current from the source Sp to the substrate P-sub by adjusting the ΔVx, that is, adjusting the amplitude of the clock signal.

Considerations to the operations at t2 and t3 described above are applicable to operations at times t4, t5, t6, and t7 shown in FIGS. 3 and 5.

In this manner, according to the first embodiment, the current from the source Sp or drain Dp to the substrate P-sub can be suppressed by using the PMIS transistor Tp0 in the last booster step BST2.

In the first embodiment, by using the PMIS transistor Tp0 in the last booster step BST2, it suffices that the gate Gp of the transistor Tp0 receives the clock signal bCLK input to the previous booster step BST1, and that the N-well in which the transistor Tp0 is formed is connected to the node N3 in common with the drain Dp. This can dispense with a gate voltage control circuit and a well voltage control circuit that the conventional PMOS booster circuit is required to include. According to the first embodiment, therefore, it is possible to realize the booster circuit having a small layout area and high boosting efficiency. That is, according to the first embodiment, it is possible to suppress the loss in the step-up voltage and improve the boosting efficiency and boosting speed without need to extend the chip area.

Conversely, if the boosting efficiency and the boosting speed are set equivalent to those according to the comparison, capacities of the capacitors C0 to C2 can be set small, accordingly. Reduction in the capacities of the capacitors C0 to C2 contributes to reduction in the layout area of the capacitors C0 to C2 and in the current consumption.

### Second Embodiment

In the first embodiment, there is often a slight delay in rising of the potential of the node N3 from that of the potential of the node N2 at the times t3, t5, and t7 shown in FIG. 3. In this case, the source voltage (Vn2) of the transistor Tp0 is instantaneously higher than the well voltage (Vout) by the potential difference ΔVx.

A booster circuit according to a second embodiment of the present invention includes a well voltage control circuit Vwell_CNT so as to prevent a forward bias between a source and a well of a transistor Tp0.

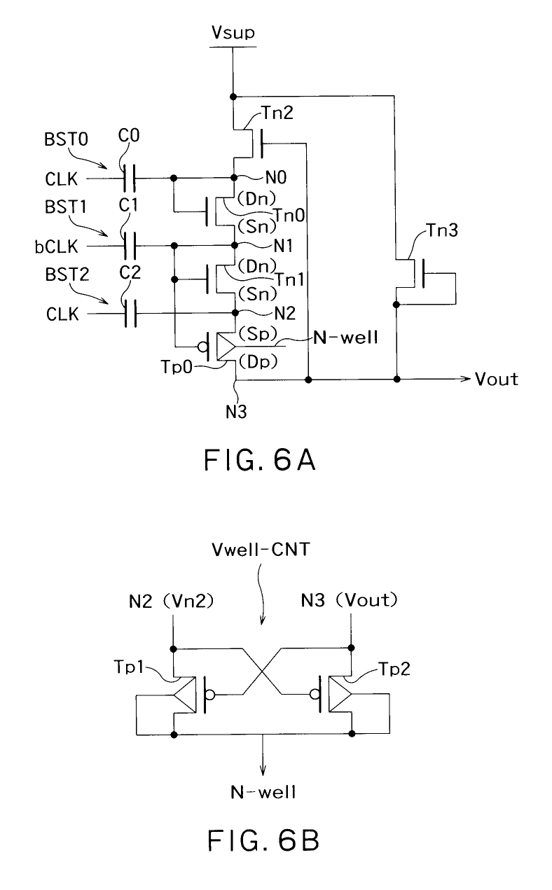

FIGS. 6A and 6B are circuit diagrams showing a configuration of the booster circuit according to the second embodiment. FIG. 6B shows a configuration of the well voltage control circuit Vwell_CNT. In the booster circuit according to the second embodiment, a body (N-well) of the transistor Tp0 is not connected to a node N3 but to the well voltage control circuit Vwell_CNT. Other configurations of the booster circuit according to the second embodiment are identical to corresponding configurations of the booster circuit according to the first embodiment. Therefore, detailed descriptions of the booster circuit shown in FIG. 6A will be omitted.

The well voltage control circuit Vwell_CNT shown in FIG. 6B includes PMIS transistors Tp1 and Tp2 (hereinafter, also “transistors Tp1 and Tp2”, respectively). The transistor Tp1 is connected to a junction between a node N2 and an N-well, and a gate of the transistor Tp1 is connected to the node N3 (an output voltage Vout). The transistor Tp2 is connected to a junction between the node N3 and the N-well, and a gate of the transistor Tp2 is connected to the node N2.

The well voltage control circuit Vwell_CNT operates if a potential difference between a voltage Vn2 of the node N2 and the voltage Vout of the node N3 exceeds a threshold voltage of the transistors Tp1 and Tp2. It is assumed that the threshold voltage of the transistors Tp1 and Tp2 is equally Vtp.

If the voltage Vn2 is higher than the voltage Vout by as much as a voltage equal to or higher than the threshold voltage Vtp, the transistor Tp1 is turned on and the transistor Tp2 is kept to be turned off. The voltage Vn2 of the node N2 higher than the voltage Vout is thereby applied to the N-well. On the other hand, if the voltage Vout is higher than the voltage Vn2 by as much as a voltage equal to or higher than the threshold voltage Vtp, the transistor Tp2 is turned on and the transistor Tp1 is kept to be turned off. The voltage Vout higher than the voltage Vn2 is thereby applied to the N-well. That is, the well voltage control circuit Vwell_CNT applies whichever higher voltage, Vout or Vn2, to the N-well. As a result, it is possible to suppress application of a forward bias to a junction between a P⁺ source Sp and the N-well and that between a P⁺ drain Dp and the N-well of the transistor Tp0.

The booster circuit according to the second embodiment operates similarly to the booster circuit according to the first embodiment described with reference to FIG. 3. However, differently from the first embodiment, the well voltage control circuit Vwell_CNT of the booster circuit according to the first embodiment connects the node N2 to the N-well if the source voltage (Vn2) of the transistor Tp0 is higher than the well voltage (Vout) as seen at the times t3, t5, and t7 in FIG. 3. That is, the well voltage control circuit Vwell_CNT applies the source voltage (Vn2) to the N-well. This can suppress the forward bias from being applied to the junction between the P⁺ source Sp and the N-well of the transistor Tp0. Other operations performed by the booster circuit according to the second embodiments are identical to those according to the first embodiment, and therefore the second embodiment can also achieve effects identical to those of the first embodiment.

In the second embodiment, the booster circuit needs the well voltage control circuit Vwell_CNT shown in FIG. 6B. Due to this, a layout area of the booster circuit according to the second embodiment is slightly larger than that of the booster circuit according to the first embodiment. Nevertheless, the booster circuit according to the second embodiment is smaller in layout area than the conventional PMOS booster circuit because there is still no need to provide the gate voltage control circuit similarly to the first embodiment.

Preferably, the threshold voltage of the transistors Tp1 and Tp2 is lower than that of the transistor Tp0 so as to fully exhibit the effects of the second embodiment. If the threshold voltage of the transistors Tp1 and Tp2 is lower than that of the transistor Tp0, then the transistor Tp1 or Tp2 can operate at higher rate than the transistor Tp0, and the well voltage can be set to a favorable voltage while the transistor Tp0 operates. As a result, even with a slight delay of rising of the potential of the node N3 from that of the potential of the node N2 as seen at the times t3, t5, and t7 shown in FIG. 3, the booster circuit can prevent the forward bias from being applied to the junction between the source Sp and N-well or the drain Dp and N-well of the transistor Tp0.

### Third Embodiment

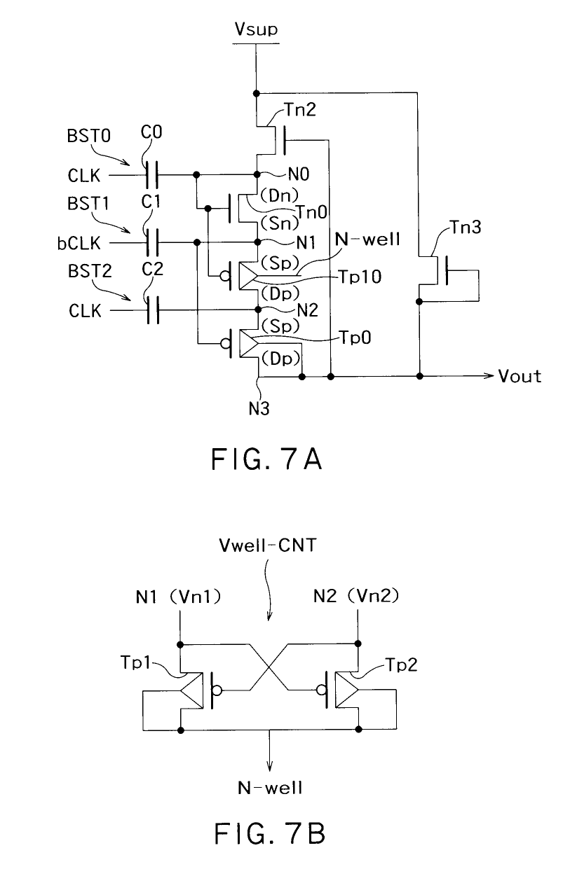

FIGS. 7A and 7B are circuit diagrams showing a configuration of a booster circuit according to a third embodiment. FIG. 7B shows a configuration of a well voltage control circuit Vwell_CNT. The booster circuit according to the third embodiment differs from that according to the first embodiment in use of PMIS transistors Tp0 and Tp10 in a plurality of booster steps BST1 and BST2, respectively. That is, in the third embodiment, not only the last booster step BST2 but also the booster step BST1 in front of the last booster step BST2 includes the PMIS transistor. Note that a transistor Tn0 is described as an example of a first MIS transistor and that a transistor Tp10 is described as an example of a second MIS transistor in third to fifth embodiments. In addition, a transistor Tp0 is described as an example of a third MIS transistor therein.

The PMIS transistor Tp10 (hereinafter, also “transistor Tp10”) is connected to between nodes N1 and N2, and a gate Gp of the transistor Tp10 is connected to a node N0 and receives a clock CLK. A source Sp of the transistor Tp10 is connected to the node N1, and a drain Dp of the transistor Tp10 is connected to the node N2. The transistor Tp10 and a capacitor C1 are paired to constitute the booster step BST1. Other configurations of the booster circuit shown in FIG. 7A are identical to corresponding configurations of the booster circuit shown in FIG. 1.

An N-well in which the transistor Tp10 is formed is connected to the well voltage control circuit Vwell_CNT shown in FIG. 7B. The well voltage control circuit Vwell_CNT shown in FIG. 7B is basically identical in configuration to that shown in FIG. 6B. Differently from the well voltage control circuit Vwell_CNT shown in FIG. 6B, however, the well voltage control circuit Vwell_CNT shown in FIG. 7B is connected to the nodes N1 and N2 and applies whichever higher voltage, Vn1 or Vn2, to the N-well of the transistor Tp10. This can suppress a forward bias from being applied to a junction between the P⁺ source Sp and the N-well or that between the P⁺ drain Dp and the N-well of the transistor Tp10.

An operation performed by the booster step BST1 is described in more detail. Operations performed by booster steps BST0 and BST2 are identical to those according to the first embodiment and therefore descriptions thereof will be omitted.

After the node N1 receives charges from the booster step BST0, a voltage Vn1 of the node N1 rises when a clock bCLK rises. At this time, the transistor Tp10 is turned on since a clock CLK falls to a low level. Accordingly, the step-up voltage Vn1 is transferred to the node N2. Furthermore, the transistor Tp10 can prevent a voltage drop in the step-up voltage by as much as a threshold voltage similarly to the transistor Tp0.

The voltage Vn1 of the node N1 is higher than a voltage Vn2 of the node N2 when the voltage Vn1 of the node N1 is stepped up. Due to this, the well voltage control circuit Vwell_CNT connects the node N1 to the N-well of the transistor Tp10. The voltage Vn1 higher than the voltage Vn2 is thereby applied to the node N2. On the other hand, the voltage Vn2 of the node N2 is higher than the voltage Vn1 of the node N1 when the voltage Vn2 of the node N2 is stepped up. Due to this, the well voltage control circuit Vwell_CNT connects the node N2 to the N-well of a transistor Tp1. The voltage Vn2 higher than the voltage Vn1 is thereby applied to the N-well. As a result, it is possible to suppress the forward bias from being applied to the junction between the P⁺ source Sp and the N-well or that between the P⁺ drain Dp and the N-well of the transistor Tp10.

Subsequently, the voltage Vn2 of the node N2 is stepped up by the clock signal CLK and the step-up voltage Vn2 is transferred to the node N3 via the transistor Tp0. Other operations performed by the booster circuit according to the third embodiment are identical to those according to the first embodiment, and therefore the third embodiment can also achieve effects identical to those of the first embodiment.

In the third embodiment, a plurality of booster steps is configured to include PMIS transistors, respectively. It is thereby possible to realize a booster circuit that further reduces a voltage loss corresponding to the threshold voltage, further improving the boosting efficiency, and further accelerating boosting speed. The last booster step BST2 of the booster circuit according to the third embodiment is configured and operates similarly to the last booster step BST2 of the booster circuit according to the first embodiment. Therefore, the third embodiments can also achieve effects of the first embodiment.

In the third embodiment, the booster circuit needs the well voltage control circuit Vwell_CNT shown in FIG. 7B. Due to this, a layout area of the booster circuit according to the third embodiment is slightly larger than that of the booster circuit according to the first embodiment. Nevertheless, the booster circuit according to the third embodiment is smaller in layout area than the conventional PMOS booster circuit because there is still no need to provide the gate voltage control circuit similarly to the first embodiment.

Preferably, a threshold voltage of the transistors Tp1 and Tp2 is lower than that of the transistor Tp10 so as to fully exhibit effects of the third embodiment. If the threshold voltage of the transistors Tp1 and Tp2 is lower than that of the transistor Tp10, then the transistor Tp1 or Tp2 can operate at higher rate than the transistor Tp10, and a well voltage can be set to a favorable voltage while the transistor Tp10 operates. As a result, the booster circuit can prevent the forward bias from being applied to the junction between the source Sp and N-well or the drain Dp and N-well of the transistor Tp10.

### Fourth Embodiment

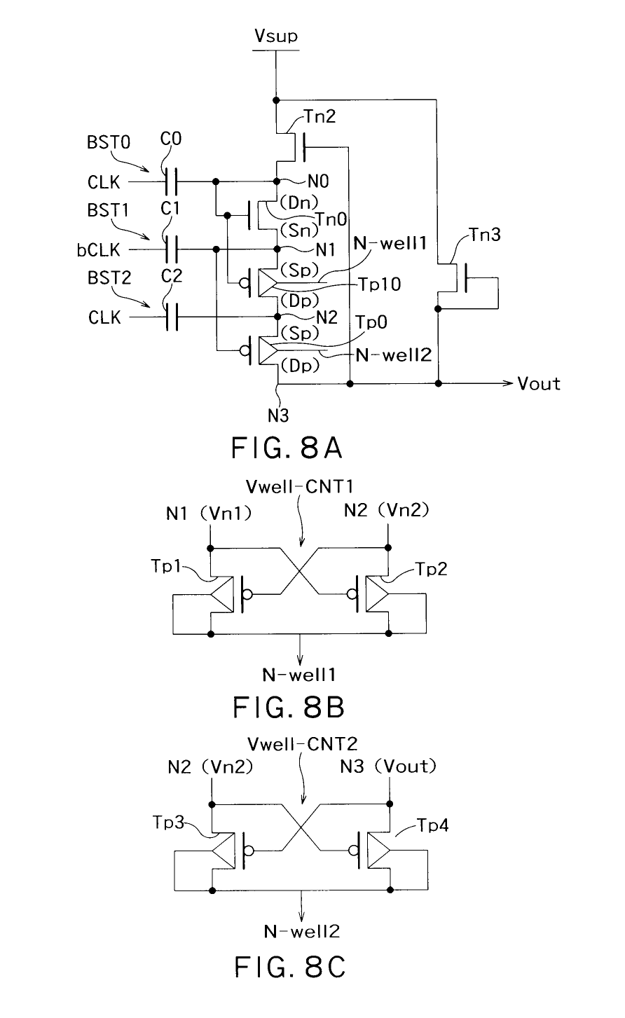

FIGS. 8A to 8C are circuit diagrams showing a configuration of a booster circuit according to a fourth embodiment. FIG. 8B shows a configuration of a first well voltage control circuit Vwell_CNT1. FIG. 8C shows a configuration of a second well voltage control circuit Vwell_CNT2.

The fourth embodiment is identical to the third embodiment in that a last booster step BST2 and a booster step BST1 in front of the last booster step BST2 use PMIS transistors Tp0 and Tp10, respectively. However, the fourth embodiment differs from the third embodiment in that a well N-well 2 of the transistor Tp0 is not connected to a node N3 but to the second well voltage control circuit Vwell_CNT2 shown in FIG. 8C. The booster circuit according to the fourth embodiment can be configured similarly to that according to the third embodiment in other respects. Therefore, the first well voltage control circuit Vwell_CNT1 shown in FIG. 8B is identical in its configuration to the well voltage control circuit Vwell_CNT shown in FIG. 7B. That is, an input of the first well voltage control circuit Vwell_CNT1 is connected to nodes N1 and N2 and an output thereof is connected to an N-well 1 of the transistor Tp10. This enables the first well voltage control circuit Vwell_CNT1 to apply whichever higher voltage, a voltage Vn1 of the node N1 or a voltage Vn2 of the node N2, to the N-well 1 of the transistor Tp10. As a result, it is possible to suppress a forward bias from being applied to a junction between a P⁺ source Sp and the N-well 1 or that between a P⁺ drain Dp and the N-well 1 of the transistor Tp10.

Moreover, the second well voltage control circuit Vwell_CNT2 shown in FIG. 8C is identical in its configuration to the well voltage control circuit Vwell_CNT shown in FIG. 6B. The second well voltage control circuit Vwell_CNT2 is configured to include PMIS transistors Tp3 and Tp4 (hereinafter, also “transistors Tp3 and Tp4”, respectively). The transistor Tp3 shown in FIG. 8C corresponds to the transistor Tp1 shown in FIG. 6B and the transistor Tp4 shown in FIG. 8C corresponds to the transistor Tp2 shown in FIG. 6B. An input of the second well voltage control circuit Vwell_CNT2 is connected to the nodes N2 and N3 and an output thereof is connected to the N-well 2 of the transistor Tp0. This enables the second well voltage control circuit Vwell_CNT2 to apply whichever higher voltage, the voltage Vn2 of the node N2 or a voltage Vout of the node N3, to the N-well 2 of the transistor Tp0. As a result, it is possible to suppress a forward bias from being applied to a junction between a P⁺ source Sp and the N-well 2 or that between a P⁺ drain Dp and the N-well 2 in the transistor Tp0.

The fourth embodiment is an embodiment of a combination of the first to third embodiments. Therefore, the fourth embodiment also has effects of the first to third embodiments.

Preferably, a threshold voltage of the transistors Tp1 and Tp2 is lower than that of the transistor Tp0 so as to fully exhibit effects of the fourth embodiment. If the threshold voltage of the transistors Tp1 and Tp2 is lower than that of the transistor Tp0, then the transistor Tp1 or Tp2 can operate at higher rate than the transistor Tp0, and a well voltage can be set to a favorable voltage while the transistor Tp0 operates. Furthermore, it is preferable that a threshold voltage of the transistors Tp3 and Tp4 is lower than that of the transistor Tp10. If the threshold voltage of the transistors Tp3 and Tp4 is lower than that of the transistor Tp10, then the transistor Tp3 or Tp4 can operate at higher rate than the transistor Tp10, and a well voltage can be set to a favorable voltage while the transistor Tp10 operates. As a result, the booster circuit can prevent the forward bias from being applied to the junction between the source Sp and N-well 1 or N-well 2 or the drain Dp and N-well 1 or N-well 2 of each of the transistors Tp0 and Tp10.

### Fifth Embodiment

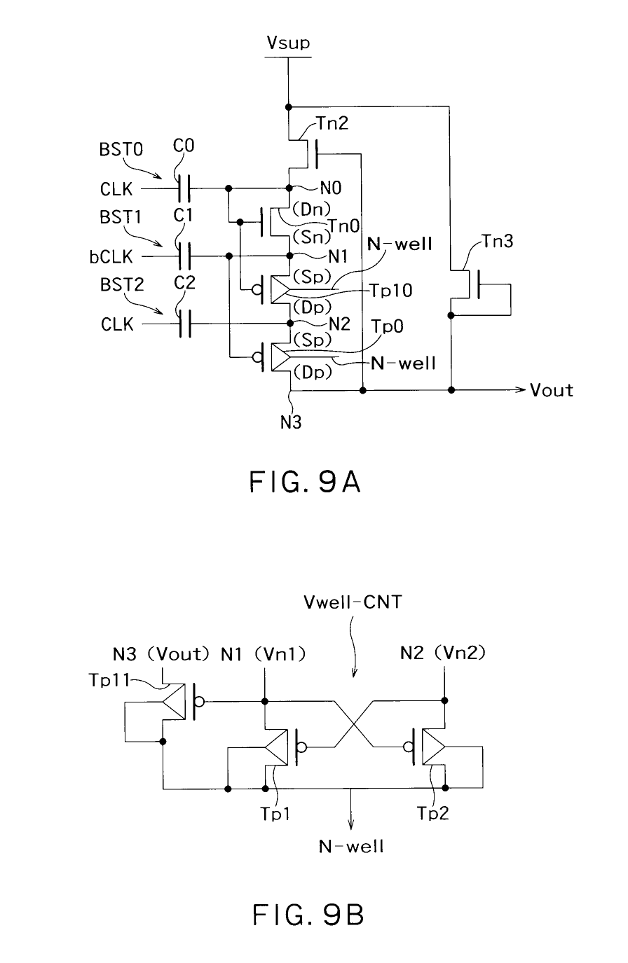

FIGS. 9A and 9B are circuit diagrams showing a configuration of a booster circuit according to a fifth embodiment. FIG. 9B shows a configuration of a well voltage control circuit Vwell_CNT. The fifth embodiment differs from the fourth embodiment in the well voltage control circuit Vwell_CNT shown in FIG. 9B. The booster circuit according to the fifth embodiment can be configured similarly to that according to the fourth embodiment in other respects. However, differently from the fourth embodiment, N-wells of transistors Tp0 and Tp10 according to the fifth embodiment are connected to the well voltage control circuit Vwell_CNT in common.

The well voltage control circuit Vwell_CNT shown in FIG. 9B includes PMIS transistors Tp1, Tp2, and Tp11 (hereinafter, also “transistors Tp1, Tp2, and Tp11”, respectively). The transistors Tp1 and Tp2 correspond to the transistors Tp1 and Tp2 shown in FIG. 8B, respectively.

The transistor Tp11 is connected to between a node N3 and an N-well. A gate of the transistor Tp11 is connected to a node N1 in common with a gate of the transistor Tp2. The N-well in which the transistors Tp1, Tp2, and Tp11 are formed is identical to the N-wells in which the respective transistors Tp0 and Tp10 are formed.

Operations performed by the transistors Tp1 and Tp2 shown in FIG. 9B are identical to those performed by the transistors Tp1 and Tp2 shown in FIG. 8B and therefore descriptions thereof will be omitted.

The transistor Tp11 operates when the gate of the transistor Tp11 receives a clock signal bCLK from the node N1. The transistors Tp11 and Tp2 are turned on when the clock signal bCLK falls to a low level. At this time, the nodes N2 and N3 are made continuous since the transistor Tp0 is also turned on. Since a voltage Vn2 of the node N2 and a voltage Vout of the node N3 are stepped up by a clock signal CLK, the voltage Vn2 or Vout higher than a voltage Vn1 of the node N1 is applied to the N-well.

On the other hand, when the clock signal bCLK rises to a high level, the transistors Tp11 and Tp2 are turned off and the transistor Tp1 is turned on according to falling of the clock signal CLK. At this time, the voltage Vn1 of the node N1 stepped up by the clock signal bCLK is applied to the N-well.

In this manner, the well voltage control circuit Vwell_CNT can connect the node with the highest voltage among the nodes N1 to N3 to the N-well. This can suppress a forward bias from being applied to a junction between a P⁺ source Sp and the N-well or that between a P⁺ drain Dp and the N-well in each of the transistor Tp0 and Tp10. That is, the fifth embodiment can also achieve effects of the fourth embodiment.

Preferably, a threshold voltage of the transistors Tp1, Tp2, and Tp11 is lower than that of the transistors Tp0 and Tp10 so as to fully exhibit effects of the fifth embodiment. If the threshold voltage of the transistors Tp1, Tp2, and Tp11 is lower than that of the transistors Tp0 and Tp10, then the transistors Tp1, Tp2, and Tp11 can operate at higher rate than the transistors Tp0 and Tp10, and a well voltage can be set to a favorable voltage while the transistor Tp0 or Tp10 operates. As a result, the booster circuit can prevent the forward bias from being applied to the junction between the source Sp and N-well or the drain Dp and N-well in each of the transistors Tp0 and Tp10

In each of the first to fifth embodiments, the booster circuit is described to be formed on the P-substrate. Alternatively, each booster circuit can be formed on an N-substrate by changing conduction types of respective constituent elements of the booster circuit. Even in this alternative, the effects of each of the above embodiments are not lost.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A booster circuit comprising:
a substrate of a first conduction type;
a first MIS transistor of a second conduction type on the substrate, the first MIS transistor being connected to between a voltage source and an output in such a manner that the first MIS transistor functions as a diode;
a first capacitor connected to a first node of the first MIS transistor on a voltage source side, and transmitting a first clock to the first node;
a second MIS transistor of the first conduction type connected to a second node of the first MIS transistor on an output side, a gate of the second MIS transistor receiving the first clock; and
a second capacitor connected to the second node, and transmitting a second clock to the second node, the second clock being opposite in a phase to the first clock, wherein
the first MIS transistor transfers a voltage of the first node stepped up by the first clock to the second node, and
the second MIS transistor transfers a voltage of the second node stepped up by the second clock to the output side.

2. The circuit of claim 1, wherein the gate of the second MIS transistor is connected to the first node.

3. The circuit of claim 1, wherein the second MIS transistor is a last booster step stepping up a voltage from the voltage source.

4. The circuit of claim 2, wherein the second MIS transistor is a last booster step stepping up a voltage from the voltage source.

5. The circuit of claim 1, wherein a channel part of the second MIS transistor receives a voltage of the output.

6. The circuit of claim 2, wherein a channel part of the second MIS transistor receives a voltage of the output.

7. The circuit of claim 3, wherein a channel part of the second MIS transistor receives a voltage of the output.

8. The circuit of claim 1, wherein a gate of the first MIS transistor is connected to the first node.

9. The circuit of claim 1, wherein a channel part of the second MIS transistor receives whichever higher voltage, the voltage of the second node or a voltage of the output.

10. The circuit of claim 2, wherein a channel part of the second MIS transistor receives whichever higher voltage, the voltage of the second node or a voltage of the output.

11. The circuit of claim 3, wherein a channel part of the second MIS transistor receives whichever higher voltage, the voltage of the second node or a voltage of the output.

12. A booster circuit comprising:
a substrate of a first conduction type;
a first MIS transistor of a second conduction type on the substrate, the first MIS transistor being connected to between a voltage source and an output in such a manner that the first MIS transistor functions as a diode;
a first capacitor connected to a first node of the first MIS transistor on a voltage source side, and transmitting a first clock to the first node;
a second MIS transistor of the first conduction type connected to a second node of the first MIS transistor on an output side, a gate of the second MIS transistor receiving the first clock;
a second capacitor connected to the second node, and transmitting a second clock to the second node, the second clock being opposite in a phase to the first clock;
a third MIS transistor of the first conduction type connected to a third node of the second MIS transistor on the voltage source side, a gate of the third MIS transistor receiving the second clock; and
a third capacitor connected to the third node, and transmitting the first clock to the third node, wherein
the first MIS transistor transfers a voltage of the first node stepped up by the first clock to the second node,
the second MIS transistor transfers a voltage of the second node stepped up by the second clock to the third node, and
the third MIS transistor transfers a voltage of the third node stepped up by the first clock to the output side.

13. The circuit of claim 12, wherein
a gate of the first MIS transistor and the gate of the second MIS transistor are connected to the first node in common, and
the gate of the third MIS transistor is connected to the second node.

14. The circuit of claim 12, wherein
a channel part of the second MIS transistor receives whichever higher voltage, the voltage of the second node or the voltage of the third node, and
a channel part of the third MIS transistor receives a voltage of the output.

15. The circuit of claim 12, wherein
a channel part of the second MIS transistor receives whichever higher voltage, the voltage of the second node or the voltage of the third node, and
a channel part of the third MIS transistor receives whichever higher voltage, the voltage of the third node or a voltage of the output.

16. The circuit of claim 12, wherein
each channel part of the second and the third MIS transistors receives the highest voltage among the voltage of the second node, the voltage of the third node and the voltage of the output.
